(19) United States
(12) Patent Application Publication
(10) Pub. No.: US 2015/0314301 A1
(43) Pub. Date: Nov. 5, 2015

(54) CRUSHER HOPPER FEED GUIDE ASSEMBLY

(71) Applicant: SANDVIK INTELLECTUAL PROPERTY AB, Sandviken (SE)

(72) Inventors: Axel BERGMAN, Malmo (SE); Bengt-Arne ERIKSSON, Svedala (SE); Fredrik ERIKSSON, Malmo (SE); Mikael M. LARSSON, Eslov (SE); Patric MALMQVIST, Svedala (SE)

(21) Appl. No.: 14/647,512

(22) PCT Filed: Nov. 6, 2013
(86) PCT No.: PCT/EP2013/073097

§ 371 Date: Jun. 15, 2015

(30) Foreign Application Priority Data
Nov. 28, 2012 (EP) 12194599.2

(51) Int. Cl. B02C 23/02; B02C 13/286; B02C 2/00

(52) U.S. Cl. CPC B02C 23/02; B02C 2/007; B02C 13/286; B02C 2013/28672

(57) ABSTRACT

A crusher feed hopper guide assembly directs material to be crushed through a lower region of an internal chamber of a feed hopper. The feed guide includes a modular construction with individual units positioned side-by-side to define a conical funnel within the hopper chamber. A plurality of wear liners are removably mounted on a plurality of common supports, with the wear liners and the modular units being removably mounted at the hopper for convenient assembly and disassembly to facilitate maintenance.

### FIELD OF INVENTION

The present invention relates to a crusher hopper feed guide and in particular, although not exclusively, to a modular feed guide that is removably mountable for positioning at a lower region of the hopper and configured to direct material to be crushed through at least a part of the hopper chamber.

### BACKGROUND ART

Gyratory crushers are used for crushing ore, mineral and rock material to smaller sizes. Typically, the crusher comprises a crushing head mounted upon an elongate main shaft. A first crushing shell is mounted on the crushing head and a second crushing shell is mounted on a frame such that the first and second crushing shells define together a crushing gap through which material to be crushed is passed. A driving device positioned at a lower region of the main shaft is configured to rotate an eccentric assembly about the shaft to cause the crushing head to perform a gyratory pendulum movement and crush the material introduced in the crushing gap. Example gyratory crushers are described in WO 2004/110626; WO 2010/123431 and WO 2012/005651.

Similarly, vertical shaft impact crushers (VSI-crushers) are used in many applications for crushing hard material like rocks, ore etc., with examples described in WO 2004/020103 and WO 2010/042025.

Common to the various types of crushers is the need for the controlled feeding of material into the crusher in order to optimise the crushing action and crusher efficiency. Typically, a feed hopper is mounted at the crusher inlet and acts to guide material into the crushing zone. To reduce damage and wear to the hopper walls replaceable wear protection liners are usually mounted within an upper region of the hopper chamber. The lower region of the chamber is protected by a feed guide in the form of plate-like sections that are mounted side-by-side to create a funnel.

Conventionally, the cone plates are manufactured from high wear resistant steel such as Hardox™. Mounting brackets are secured to an upper region of each plate and are secured directly to the hopper wall via anchorage bolts. Mounting is facilitated by a series of lugs that extend inwardly from the hopper wall onto which the brackets are hanged prior to fixed attachment via the bolts. The construction and mounting of the conventional feed guide sections is disadvantageous for a number of reasons.

Typically, the attachment bolt holes through the brackets and hopper wall are drilled during mounting of the cone sections. When worn cones are replaced it is common for the holes of the replacement bracket not to align with the holes in the feed hopper and these must then be welded shut which is time consuming and labour intensive. Additionally, when removing worn cone sections, the fastening bolts, due to their exposed positioning to the feed material, are often impossible to unfasten and must to be cut. Again this is inefficient and wasteful. Furthermore, when the working/material contact surface of the plate-like cone unit is worn, the entire cone section must be replaced, due to its integral construction. This is inefficient with regard to use of materials, labour and the transport of the heaving and bulky guide sections.

### SUMMARY OF THE INVENTION

It is an object of the present invention to provide a modular feed guide for a crusher hopper that is convenient to mount and dismount at the hopper and is efficient to maintain with regard to the replacement of worn components.

The objective is achieved by providing a modular constructed feed guide in which worn component parts may be conveniently removed and replaced without the need to replace the entire assembly and in particular other components that are not yet ready for replacement. Additionally, the present guide is specifically configured to be conveniently mounted and disassembled from the hopper to provide for the convenient replacement of the wear parts components. In particular, the attachment components used to secure the present feed guide to the hopper are positioned so as to be shielded from the flow of crushable material to prevent wear and damage to these components.

According to a first aspect of the present invention there is provided a crusher hopper feed guide assembly to direct material to be crushed through at least a lower region of an internal chamber of a crusher feed hopper, the feed guide comprising: a frame configured for positioning at a wall of the feed hopper that defines the internal chamber; characterised by: a mount member to releasably mount at least one wear protection liner, the frame supporting the mount member within the internal chamber; at least one attachment element to releasably mount the at least one wear liner at the mount member; the mount member configured to mount the wear liner to extend away from the wall at a declined angle towards a bottom end of the hopper.

By detachably mounting the wear protection liners at a region of the support and/or frame of the feed guide assembly, a worn wear liner may be removed and replaced conveniently whilst other components of the assembly and in particular other wear liners are retained. The attachment components of each replaceable wear liner are provided at a rear or underside part of the liner and are therefore not exposed to the crushable material in use. Accordingly, such components are protected from wear and maintain their integrity.

Preferably, the at least one mount member comprises a plate-like body. Optionally, the at least one attachment element comprises a plurality of holes extending through the mount member to receive respective elongate attachment lugs projecting from a rear region of the wear liner. Alternatively, other releasable attachment means may be used such as snap-click, bayonet, or push-fit connections, interlocking flanges or tongue and groove arrangements.

Preferably, the frame comprises a lower support region and an upper support region, the lower support region projecting rearwardly from the mount member by a greater distance than the projection of the upper support region.

Preferably, the plate-like body comprises an upper edge, a lower edge and two side edges, the body comprising a generally curved profile in a direction between the side edges.

Optionally, where the releasable attachment means comprises holes and bolts, a first row of holes is positioned towards the upper edge and a second row of holes is positioned towards a lower edge.

Optionally, the frame comprises a plurality of wedge-shaped bodies that extend from a rear region of the mount member to contact the wall of the hopper. Preferably, the assembly further comprises a first anchorage flange to project inwardly from the wall and to mount the frame at a lower region of the hopper. Preferably, the assembly comprises a second anchorage flange mountable at the hopper to trap at least a part of the assembly between the first and the second flanges to mount the frame at a region of the hopper. Preferably, the second flange abuts the mount member at a region at or towards the upper edge.

Preferably, the frame further comprises a plurality of braces mountable at the wall and a plurality of mounting lugs to be mounted respectively at the braces.

According to a second aspect of the present invention there is provided a set of hopper feed guide units positionable at a lower region of an internal chamber of a hopper to direct material to be crushed through the hopper, the set comprising: a plurality of feed guide assemblies as detailed herein.

According to a third aspect of the present invention there is provided a crusher feed hopper for mounting upon a crusher, the hopper comprising: at least one wall defining an internal hopper chamber into which material to be crushed is fed to the crusher; a material deflector to direct material to be crushed through at least a lower region of an internal chamber of the hopper, the deflector comprising: at least one feed guide assembly as described herein.

Preferably, the hopper comprises a plurality of feed guide assemblies as described herein;

wherein the feed guide assemblies are positioned side-by-side to extend around a central longitudinal axis of the hopper, each of the wear liners extending away from the wall at a declined angle towards the bottom end of the hopper, such that the wear liners define substantially at least a part of a funnel assembly having an internal cross sectional area that tapers inwardly towards the bottom end of the hopper.

According to a fourth aspect of the present invention there is provided a crusher comprises a feed hopper as described herein.

### BRIEF DESCRIPTION OF DRAWINGS

A specific implementation of the present invention will now be described, by way of example only, and with reference to the accompanying drawings in which:

FIG. 1 is a perspective view of a crusher feed hopper comprising a modular feed guide positioned at a lower region of an internal chamber of the feed hopper according to a specific implementation of the present invention;

FIG. 2 is a perspective view of the hopper and guide of FIG. 1 with a main component of the guide removed to show part of the mounting component according to a specific implementation of the present invention;

FIG. 3 is a perspective underside view of the hopper of FIG. 1 showing the modular feed guide mounted at a lower region of the hopper internal chamber;

FIG. 4 is a front perspective view of a part of the feed guide of FIG. 3;

FIG. 5 is a perspective rear view of the feed guide part of FIG. 4;

FIG. 6 is a side perspective view of the feed guide part of FIG. 5;

FIG. 7 is a front perspective view of the feed guide part of FIG. 6 comprising a plurality of wear liners mounted upon the guide according to a specific implementation of the present invention;

FIG. 8 is a rear perspective view of the feed guide and wear liners of FIG. 7;

FIG. 9 is a rear perspective view of a single wear liner of FIGS. 7 and 8 according to a specific implementation of the present invention.

### DETAILED DESCRIPTION OF PREFERRED EMBODIMENT OF THE INVENTION

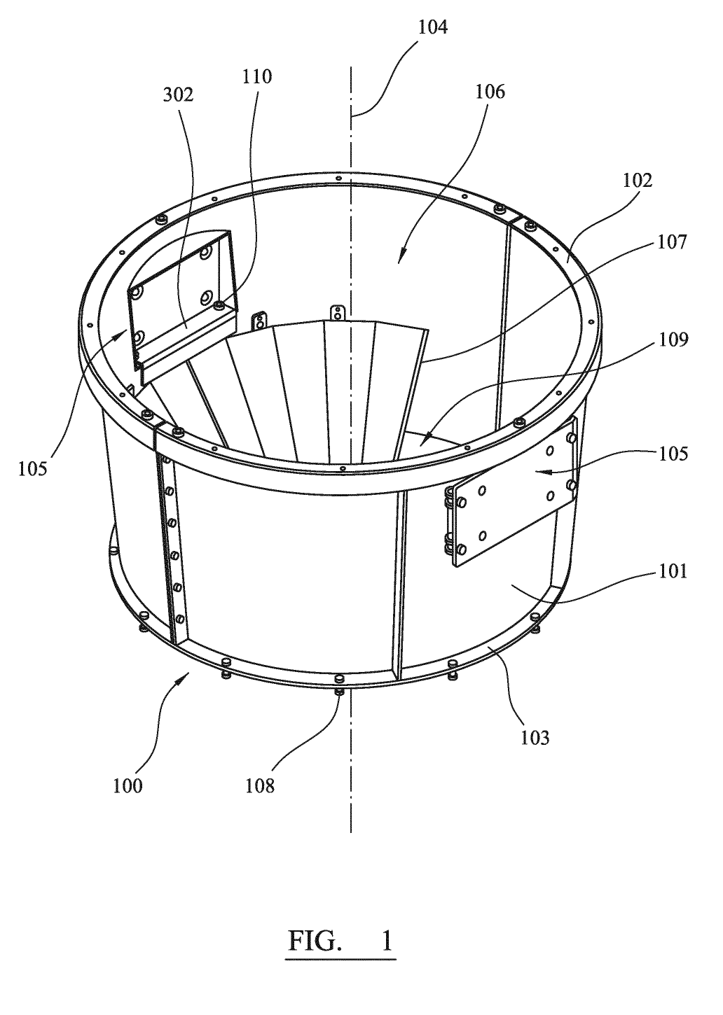

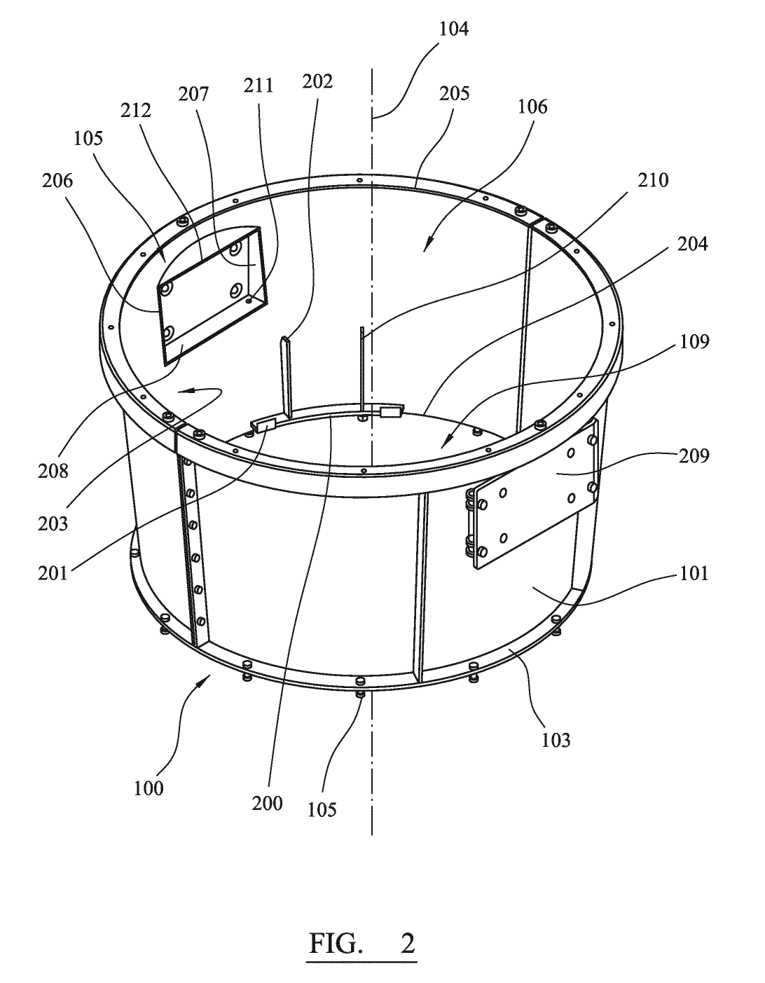

Referring to FIGS. 1 and 2, hopper 100 comprises a main hopper side wall 101 that extends circumferentially around a central longitudinal axis 104 of hopper 100. Wall 101 extends from an uppermost end 102 to a lowermost end 103 with end 103 suitable for mounting upon a crusher (not shown). Accordingly, uppermost end 102 is positioned furthest from the crusher (not shown). Hopper 101 is mounted at the crusher, or an intermediate component part, via mounting bolts 108 at lowermost end 103. In use, material to be crushed is fed into the open uppermost end of hopper 102 and is discharged through opening 109 at the lowermost end 103.

To assist with the directing and feeding of material to be crushed through hopper 100, hopper wall 101 is orientated to taper inwardly from uppermost end 102 towards lower end 103 relative to longitudinal axis 104. That is, relative to axis 104, wall 101 is tangential at an angle of substantially 5° to define a frusto-cone shaped profile. Accordingly, a cross sectional area (relative to axis 104) of lowermost end 103 is less than a corresponding cross sectional area at uppermost end 102.

Wall 101 defines an internal hopper chamber 106 extending between uppermost and lowermost ends 102, 103. To allow access into chamber 106, a hatch 105 having a door and frame, is mounted at wall 101 being common to conventional crusher hoppers.

To protect a lower region of wall 101 and to facilitate directing of the feed material into the crusher (not shown), a feed guide 107 is mounted in the lower half of hopper 100. Feed guide 107 comprises a modular construction to allow convenient mounting and disassembly at internal chamber 106 as the various components wear following extended use.

A working surface of feed guide 107 is orientated generally towards longitudinal axis 104 and extends away from wall 101, within internal chamber 106, at a declined (downward) angle towards bottom end 103. The working surface of feed guide 107 defines at least a part of a cone with an upper end of the cone positioned approximately at a mid-height region (relative to a lower circumferential edge 204 and an upper circumferential edge 205 of hopper 100) whilst a lower region of the cone is aligned approximately co-planar with lower edge 204.

Two access openings 206 are positioned diametrically opposite relative to axis 104 within wall 101. Each opening 206 is concealed by a respective externally mounted hatch door 209. A perimeter of each opening 206 is bordered by a lower sill 208, an upper sill 212 and a pair of side sills 207 that project outwardly from wall 101 relative to internal chamber 106. Bottom sill 208 is aligned perpendicular to axis 104 and is positioned approximately at a mid-height region relative to lower circumferential edge 204 and upper circumferential edge 205. Hatch door 209 abuts against the outermost edge of each sill 207, 208, 212 to close opening 206.

A first anchorage flange 200 is the form or an elongate arcuate strip extends inwardly from an internal surface 203 of wall 101 at lower end 103. Flange 200 comprises a pair of lugs 201 positioned at each end of flange 200 and mounted at an innermost edge of flange 200. Flange 200 is aligned perpendicular to axis 104 whilst lugs 201 are aligned parallel with axis 104. The attachment of flange 200 to inner surface 203 is strengthened by a pair of elongate braces 202 that extend from the lower end 103 to an approximate mid-height region of hopper 100 (relative to a lower circumferential edge 204 and an upper circumferential edge 205). Each brace 202 is substantially straight and is secured in position by welding to inner surface 203 and an upper face of flange 200. An uppermost end 210 of each brace 202 projects inwardly from surface 203 towards axis 104 and provides a mounting region for a part of the guide 107. Flange 200 and lugs 201 provide a first (lower) support region for guide 107. As detailed below, feed guide 107 is releasably mounted in position at chamber 106 inter alia via cooperation between the first flange 200 and a second anchorage flange 302. Second flange 302 is, in turn, removable retaining in position at sill 208 by a pair of anchorage bolts 110 received within a pair of holes 211 provided in sill 208.

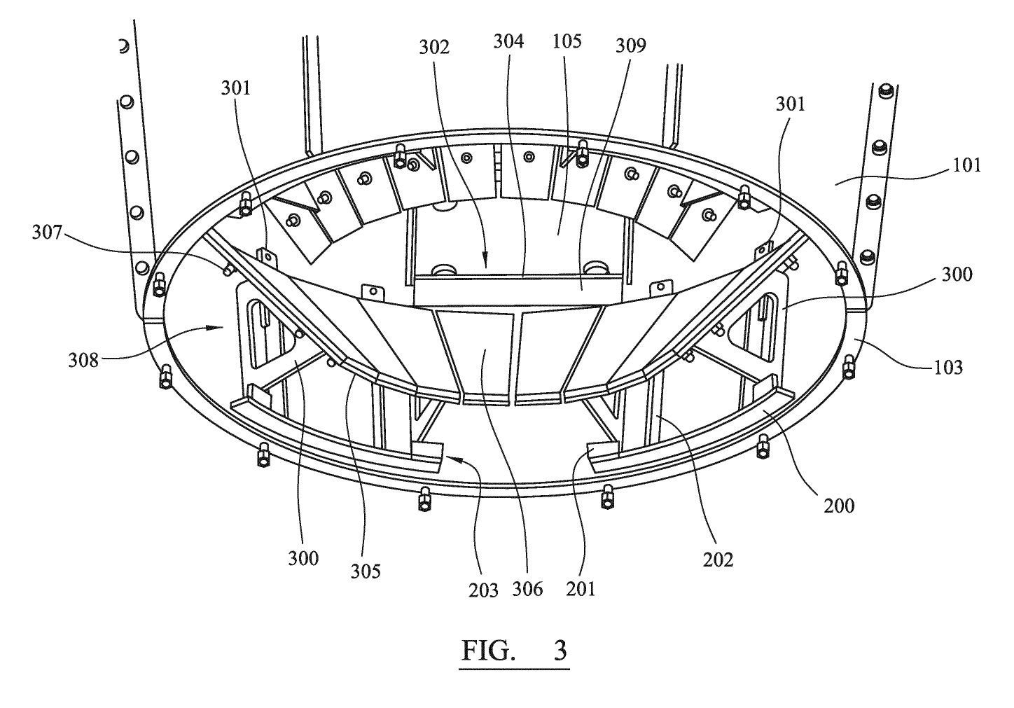

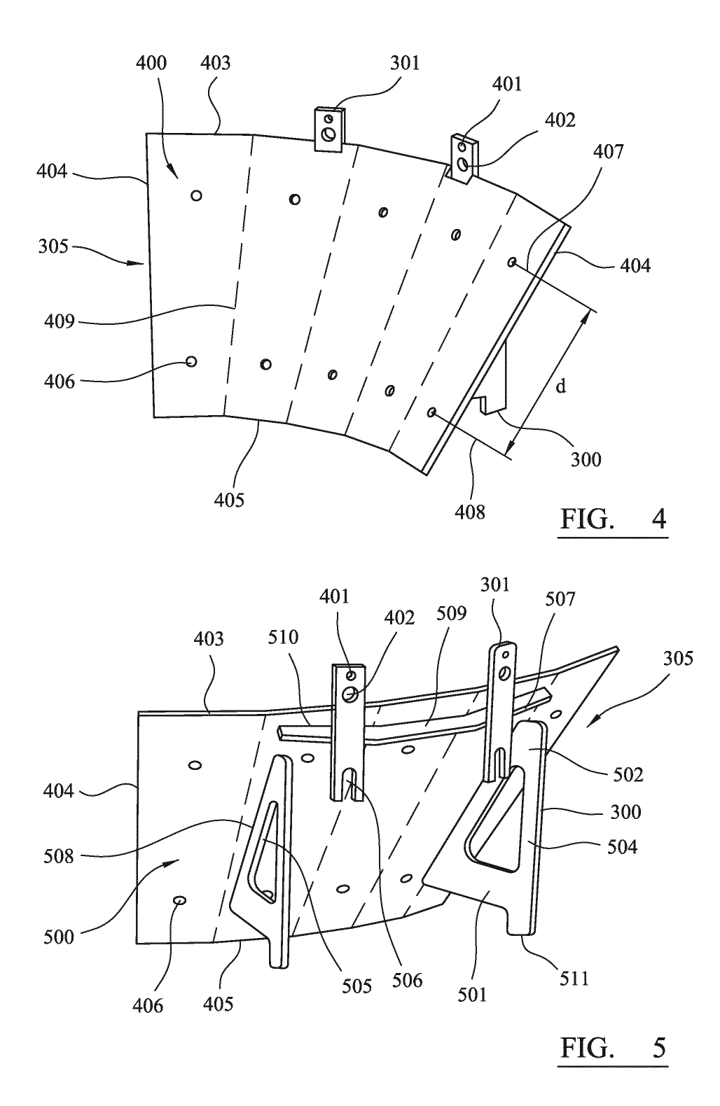

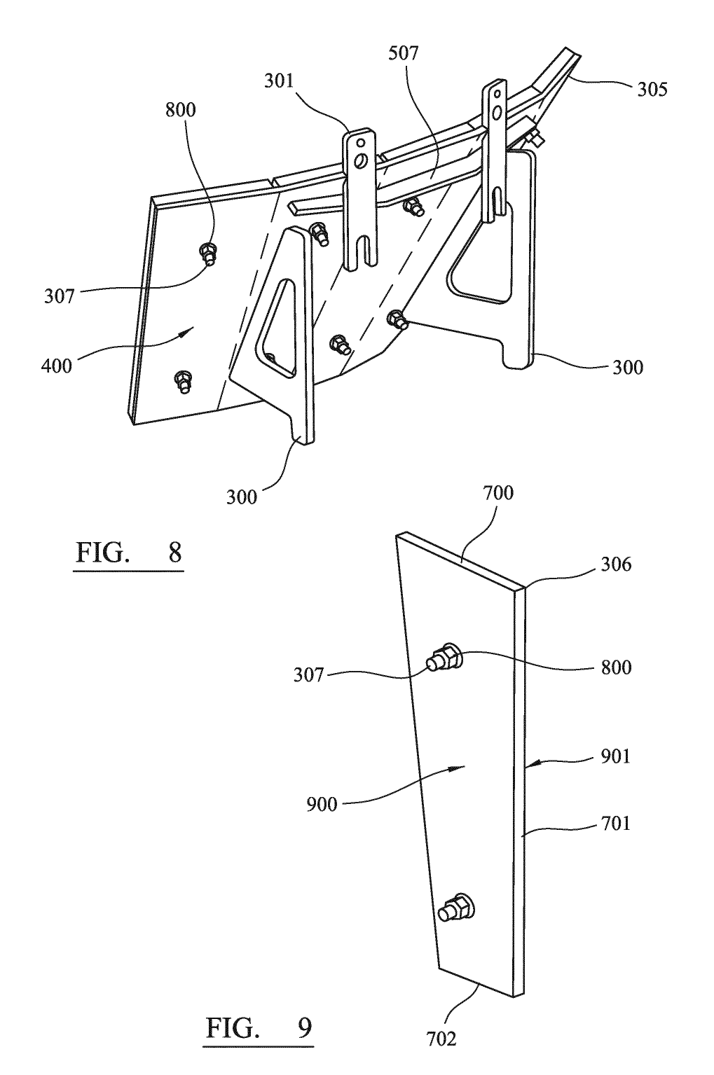

FIG. 3 is an underside perspective view of hopper 100 through the lower discharge opening 109. Feed guide 107 is formed as an assembly of independent guide units 308 positioned side-by-side circumferentially around inner surface 203 of wall 101. Each unit 308 comprises a frame 300 that is mounted at wall 101 via the first and second flanges 200 and 302. Frame 300 positionally supports a plate-like mounting member 305 that, in turn, positionally supports a plurality of individual wear liners 306 mounted upon each mount 305. The frame 300 of each unit 308 comprises a pair of wedge-shaped brackets. Referring to FIGS. 4 to 9, each bracket 300 comprises a vertical leg 504 aligned parallel with axis 104. A first upper arm 502 projects laterally from an upper region of leg 504 towards a rear surface 500 of mount member 305. A lower arm 501 projects laterally from a lower region of leg 504 to also contact rear surface 500 of mount member 305. Each arm 501, 502 is connected at their respective ends (furthest from leg 504) by a connecting strut 505. Strut 505 is attached to rear face 500 via welding 508 or other suitable attachment.

Due to the relative length of the upper 502 and the lower 501 arms, mount member 305 is retained at a declined orientation relative to vertical leg 504.

Each bracket 300 extends in a direction of longitudinal axis 104 between a lower edge 405 and an upper edge 403 of mount member 305. A further frame component 509 is formed as an elongate strip that projects laterally from rear face 500 and is positioned towards upper edge 403. Strip 509 is secured to face 500 via welding 510 and is aligned perpendicular to brackets 300. A leading edge 507 of strip 509, furthest from face 500, provides a mounting region for a pair of mounting lugs 301. Each lug 301 comprises an elongate plate-like body having a first hole and a second hole 402 positioned through its upper half and a notch 506 indented in a lower edge. Each lug 301 is aligned with axis 104 and is spaced rearwardly from rear face 500 by mounting strip 509.

The plate-like mount member 305 comprises a generally curved profile in a direction between a pair of side edges 404 that extend perpendicular to bottom 405 and top 403 edges. The curved profile is created by low angle bend/crease regions 409 that extend linearly between top and bottom edges 403, 405. Each bend 409 is spaced uniformly between edges 404. A length of bottom edge 405 is less than top edge 403 such that mount member 305 defines a section of a frusto-conical funnel. In the side-by-side configuration, each unit 308 defines a guide funnel by virtue of each plate-like mount member 305.

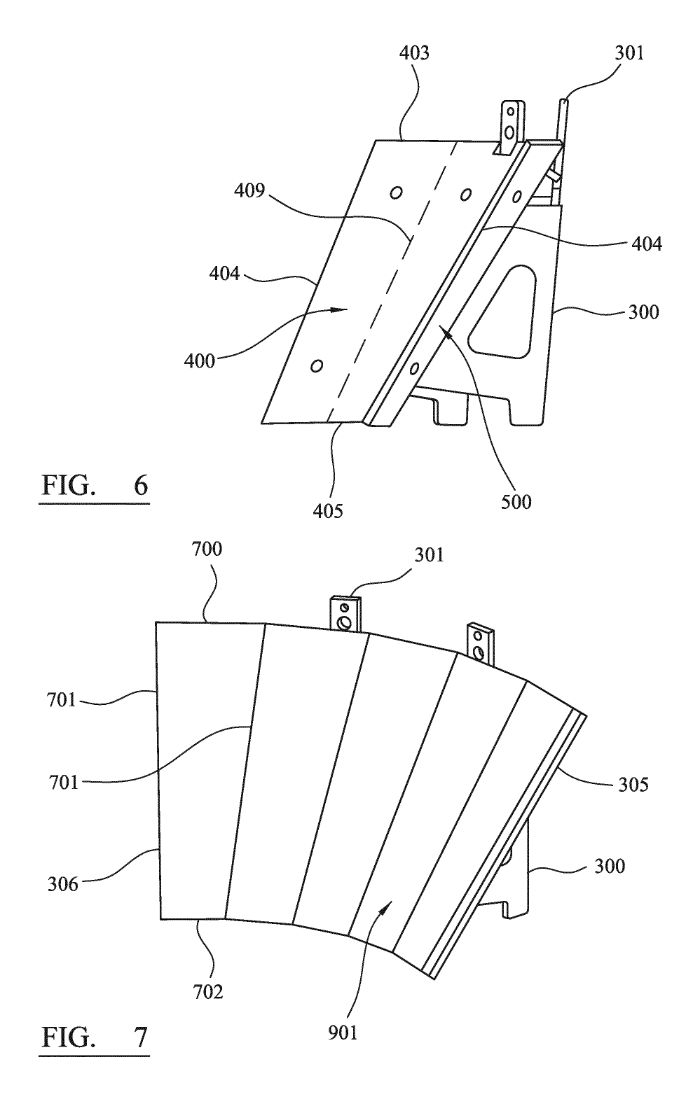

As illustrated in FIG. 3, a plurality of wear liners 306 are individually mounted and retained at each mounted member 305. Referring to FIG. 7, each wear liner 306 is substantially elongate and comprises side edges 701 and a top 700 and a bottom 702 edge. Each liner 306 also comprises a generally trapezoid configuration to enable five identical liners to be accommodated side-by-side upon front face 400 of member 305 and to sit within perimeter edges 403, 404, 405. Liners 306 comprise a high hardness steel and are formed from a different material to that of mount member 305. Preferably, each wear liner 306 comprises Hardox™.

Each liner 306 comprises a front working surface 901 and a rear surface 900 referring to FIG. 9. A pair of elongate projections 307 (each in the form of an elongate threaded bolt shaft) extend from rear face 900. Front face 901 is substantially planar and is configured to withstand the impact loading forces resultant from contact with the crushable material passing within internal chamber 106. Each liner 306 is dimensioned to sit within the substantially planar region of member 305 between each elongate bend 409.

A plurality of holes 406 extend through member 305 between front face 400 and rear face 500. The holes 406 are arranged in rows with a first row 407 positioned towards top edge 403 and a second row 408 positioned towards bottom edge 405. The holes 406 of each row 407, 408 are spaced apart by a uniform distance (d). Each liner 306 is secured at face 400 as the pair of threaded shafts 307 are inserted through the respective upper and lower pair of holes 406. Each liner 306 is then secured by an attachment nut 800. Importantly, shaft 307 and nut 800 are positioned rearwardly of working surface 901 so as to be shielded from contact with the crushable material.

The releasable mounting of each unit 308 at chamber interior 106 is achieved by via the releasably mounted flange 302. In particular, flange 302 comprises an elongate right-angle component in which a first elongate strip 309 extends perpendicular to second strip 304, with each strip 309, 304 connected along one of their lengthwise edges. Strip 304 is dimensioned so as to sit on top of lowermost hatch sill 208 as detailed above via mounting bolts threaded through sill apertures 211. When mounted in position, the first strip 309 overhangs sill 208 at its internal side so as to project downwardly a short distance below hatch opening 206. Strip 309 stands proud of internal surface 203. Additionally, strip 309 is substantially linear and this configuration provides further clearance with the curved cylindrical wall 101.

Positional retention and secure mounting of each unit 308 within chamber 106 is achieved by ‘sandwiching’ each unit 308 in a substantially vertical orientation between lower flange 200 and upper flange 302. That is, a foot 511 extending from a lower region of leg 504 is configured to abut onto an upper surface of flange 200. Each lower arm 501 is also positioned to rest on top of an upper edge of each respective lug 201 extending upwardly from flange 200. This configuration ensures that each unit 308 does not fall downwardly through lower opening 109. To prevent each unit 308 being deflected inwardly from secure mounting against internal surface 203, upper flange 302 is positioned to abut the upper edge 403 of mount member 305. As flange 302 is bolted down onto lower sill 208, each unit 308 is axially compressed onto lower flange 200 so as to be retained in position against inner surface 203.

Optionally, additional mounting screws, bolts or pins may be inserted through holes 401 and 402 of each upper mounting lug and to be secured through hopper wall 101. However, bolted or screwed attachment via upper mounting lugs 301 may reduce the speed and convenience of mounting and disassembly as these components may be subject to wear as described previously.

Units 308 are further stabilised in position as each notch 506 is seated onto the respective upper edge 210 of the respective brace 202. The mounting and dismounting procedure of each unit 308 and each wear liner 306 is achieved simply by opening hopper hatch 305, removing anchorage bolts 110 to release upper anchorage flange 302. Each unit 308 may then be lifted from hopper chamber 106 independently of other units 308. The worn wear liners 306 may then be removed by removal of attachment nuts 800. With new replacement liners installed, the repaired unit 308 may then be lowered into position via mating of feet 501 upon flange 200 and notches 506 onto braces 202. The upper flange 302 is then remounted at sill 208 to wedge each unit 308 in position against hopper wall 101.

1. A crusher hopper feed guide assembly to direct material to be crushed through at least a lower region of an internal chamber of a crusher feed hopper, the feed guide comprising:
a frame configured for positioning at a wall of the feed hopper that defines the internal chamber;
a mount member for releasably mounting at least one wear protection liner, the frame supporting the mount member within the internal chamber; and
at least one attachment element for releasably mounting the at least one wear liner at the mount member; the mount member being configured to mount the wear liner to extend away from the wall at a declined angle towards a bottom end of the hopper.

2. The assembly as claimed in claim 1, wherein the at least one mount member has a plate-like body.

3. The assembly as claimed in claim 1, wherein the at least one attachment element includes a plurality of holes extending through the mount member to receive respective elongate attachment lugs projecting from a rear region of the wear liner.

4. The assembly as claimed in claim 1, wherein the frame includes a lower support region and an upper support region, the lower support region projecting rearwardly from the mount member by a greater distance than the projection of the upper support region.

5. The assembly as claimed in claim 2, wherein the plate-like body includes an upper edge, a lower edge and two side edges, the body having a generally curved profile in a direction between the side edges.

6. The assembly as claimed in claim 5, further comprising a first row of holes positioned towards the upper edge and a second row of holes positioned towards a lower edge.

7. The assembly as claimed in claim 1, wherein the frame includes a plurality of wedge-shaped bodies that extend from a rear region of the mount member to contact the wall of the hopper.

8. The assembly as claimed in claim 1, further comprising a first anchorage flange projecting inwardly from the wall and mounting the frame at a lower region of the hopper.

9. The assembly as claimed in claim 8, further comprising a second anchorage flange mounted at the hopper to trap at least a part of the assembly between the first and the second flanges to mount the frame at a region of the hopper.

10. The assembly as claimed in claim 5, further comprising a first anchorage flange projecting inwardly from the wall and a second anchorage flange mounted at the hopper to trap at least a part of the assembly between the first and the second flanges to mount the frame at a region of the hopper, wherein the second flange abuts the mount member at a region at or towards the upper edge.

11. The assembly as claimed in claim 1, wherein the frame further comprises a plurality of braces mounted at the wall and a plurality of mounting lugs mounted respectively at the braces.

12. A set of hopper feed guide units positionable at a lower region of an internal chamber of a hopper to direct material to be crushed through the hopper, the set comprising:
a plurality of feed guide assemblies, each feed guide assembly including a frame configured for positioning at a wall of the hopper that defines the internal chamber; a mount member that releasably mounts at least one wear protection liner, the frame supporting the mount member within the internal chamber; and at least one attachment element releasably mounting the at least one wear liner at the mount member, the mount member being configured to mount the wear liner to extend away from the wall at a declined angle towards a bottom end of the hopper.

13. A crusher feed hopper for mounting upon a crusher, the hopper comprising:
at least one wall defining an internal hopper chamber into which material to be crushed is fed to the crusher;
a material deflector to direct material to be crushed through at least a lower region of an internal chamber of the hopper, the deflector including at least one feed guide assembly, the at least one feed guide assembly including a frame configured for positioning at a wall of the hopper that defines the internal chamber; a mount member that releasably mounts at least one wear protection liner, the frame supporting the mount member within the internal chamber; and at least one attachment element releasably mounting the at least one wear liner at the mount member, the mount member being configured to mount the wear liner to extend away from the wall at a declined angle towards a bottom end of the hopper.

14. The hopper as claimed in claim 13, further comprising a plurality of feed guide assemblies, wherein the feed guide assemblies are positioned side-by-side to extend around a central longitudinal axis of the hopper, each of the wear liners extending away from the wall at a declined angle towards the bottom end of the hopper, such that the wear liners define substantially at least a part of a funnel assembly having an internal cross sectional area that tapers inwardly towards the bottom end of the hopper.

15. A crusher comprising:
a feed hopper, the feed hopper having at least one wall defining an internal hopper chamber into which material to be crushed is fed to the crusher and a material deflector to direct material to be crushed through at least a lower region of an internal chamber of the feed hopper, the deflector including at least one feed guide assembly, the at least one feed guide assembly including a frame configured for positioning at a wall of the hopper that defines the internal chamber; a mount member that releasably mounts at least one wear protection liner, the frame supporting the mount member within the internal chamber; and at least one attachment element releasably mounting the at least one wear liner at the mount member, the mount member being configured to mount the wear liner to extend away from the wall at a declined angle towards a bottom end of the hopper.
